(19) United States
(12) Patent Application Publication
(10) Pub. No.: US 2005/0273228 A1
(43) Pub. Date: Dec. 8, 2005

(54) Vehicle inspection management system and method

(75) Inventors: Tomohiro Tsubota, Tokyo (JP); Norichika Kimura, Tokyo (JP); Shigeo Kambe, Okazaki-shi (JP)

Correspondence Address: BIRCH STEWART KOLASCH & BIRCH, PO BOX 747, FALLS CHURCH, VA, 22040-0747, US

(73) Assignees: Mitsubishi Jidosha Engineering Kabushiki Kaisha, Okazaki-shi (JP); Mitsubishi Jidosha Kogyo Kabushiki Kaisha, Tokyo (JP)

(21) Appl. No.: 11/090,026

(22) Filed: Mar. 28, 2005

(30) Foreign Application Priority Data
Mar. 29, 2004 (JP) 2004-096549

(51) Int. Cl. G01M 17/00

(52) U.S. Cl. 701/29; 701/35

(57) ABSTRACT

An inspection item displayed on a liquid crystal display is inspected through a mobile inspection terminal in the state that the inspection screen is displayed. A time necessary to the inspection is measured as an actual inspection time. On the completion of inspection on one inspection screen, the measured actual inspection time is compared with the upper limit value and the lower limit value of a standard inspection time received from a server, and when the actual inspection time deviates from the upper limit value and the lower limit value, a warning is issued by displaying an inspection time warning dialog on the liquid crystal display.

### CROSS-REFERENCE TO RELATED APPLICATIONS

This application is based upon and claims the benefit of priority from prior Japanese Patent Application No. 2004-096549, filed Mar. 29, 2004, the entire contents of which are incorporated herein by reference.

### BACKGROUND OF THE INVENTION

1. Field of the Invention

The present invention relates to a vehicle inspection management system and method in a vehicle manufacturing line.

2. Description of the Related Art

Heretofore, there is known a system in which a plurality of inspection processes are applied to finished vehicles in a vehicle manufacturing line, and in the respective inspection processes inspection data is downloaded from a host computer to a personal computer, an inspection worker (hereinafter, abbreviated as “inspection worker”) executes inspections based on the inspection data, and a result of the inspection is input to the personal computer and transmitted to the host computer.

Further, there is also known a system in which, at the beginning of inspection, an inspection instruction sheet, on which reference data necessary to the inspections executed in the respective inspection processes is printed using bar codes, is attached to a finished vehicle, reference data is obtained by reading a corresponding bar code in a first process, and an inspection is executed based on the reference data, and a result of the inspection is issued in the form of a bar code label which is adhered to the inspection instruction sheet and transferred to a next process (Jpn. Pat. Appln. KOKAI Publication No. 2002-12177).

Incidentally, it is difficult to set a standard operation time necessary for an inspection job executed in each process and to cause a worker in charge of inspection (hereinafter, abbreviated as “inspection worker”) to keep the time, different from a job for assembling parts. Accordingly, whether a time taken in an inspection job increases or decreases greatly depends on the inspection worker. When for example, an assembly job is executed intensively in a manufacturing line because it is delayed, a time taken for inspection is greatly reduced, which results in a possibility that the inspection job is executed insufficiently.

An object of the present invention is to provide a vehicle inspection management system and method capable of issuing a warning to an inspection worker when an operation time necessary for inspection is longer or shorter than a standard operation time by measuring a time taken in an inspection job in each process and comparing the time with the standard operation time.

Another object of the present invention is to provide a vehicle inspection management system capable of notifying an inspection worker of a standard time necessary for inspection through an inspection terminal.

A further object of the present invention is to provide a vehicle inspection management system capable of managing the number of times of warning issued to each inspection worker.

### BRIEF SUMMARY OF THE INVENTION

According to one aspect of the present invention, there is provided a vehicle inspection management system comprising:

a server for use in a vehicle manufacturing line; and inspection terminals which communicate with the server through a LAN, wherein the server comprises:

an inspection master database configured to store inspection standard information of the vehicle and to register the standard inspection times for respective inspection items and threshold values for issuing warning to a worker in charge of inspection when the standard inspection times deviate;

an inspection result database configured to store actual inspection times on one inspection screen transmitted from the inspection terminals;

first transmission means configured to, when vehicle reception is input from the inspection terminal, read out the inspection standard information of the vehicle in a process and transmit the inspection standard information to the inspection terminal; and

second transmission section configured to determine the upper limit values and the lower limit values of the standard inspection times on the one inspection screen from the standard inspection times of the respective inspection items and the threshold value for warning and transmit the upper limit values and the lower limit values to the inspection terminal, and each of the inspection terminals comprises:

a display;

first display section configured to receive the inspection standard information of the vehicle to be inspected from the server and display an inspection screen on the display;

time measurement section configured to measure actual inspection times when inspection jobs are executed for the inspection items on the one inspection screen being displayed;

comparison section configured to, on the completion of the inspection jobs of the respective inspection items displayed on the one inspection screen, compare the actual inspection times measured by the time measurement means with the upper limit values or the lower limit values of the standard inspection times; and

second display section configured to, when the results of comparison deviates from the threshold values, display warnings including the results of comparison on the display as an inspection time warning dialog screen.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a vehicle inspection management system according to an embodiment of the present invention;

FIG. 2 is a block diagram showing a hardware arrangement of a sever of the embodiment;

FIG. 3 is a block diagram showing a hardware arrangement of a master management terminal of the embodiment;

FIG. 4 is a block diagram showing a hardware arrangement of a mobile inspection terminal of the embodiment;

FIG. 5 is a flowchart showing main processing executed by the server of the embodiment;

FIG. 6 is a flowchart showing main processing executed by the mobile inspection terminal of the embodiment;

FIG. 7 is a view showing an example of a master data input screen for determining the upper limit value and the lower limit value of an standard inspection time through the master management terminal in the embodiment; and

FIG. 8 is a view showing an example of an inspection time warning dialog displayed on the mobile inspection terminal in the embodiment.

### DETAILED DESCRIPTION OF THE INVENTION

An embodiment of the present invention will be explained below with reference to the drawings.

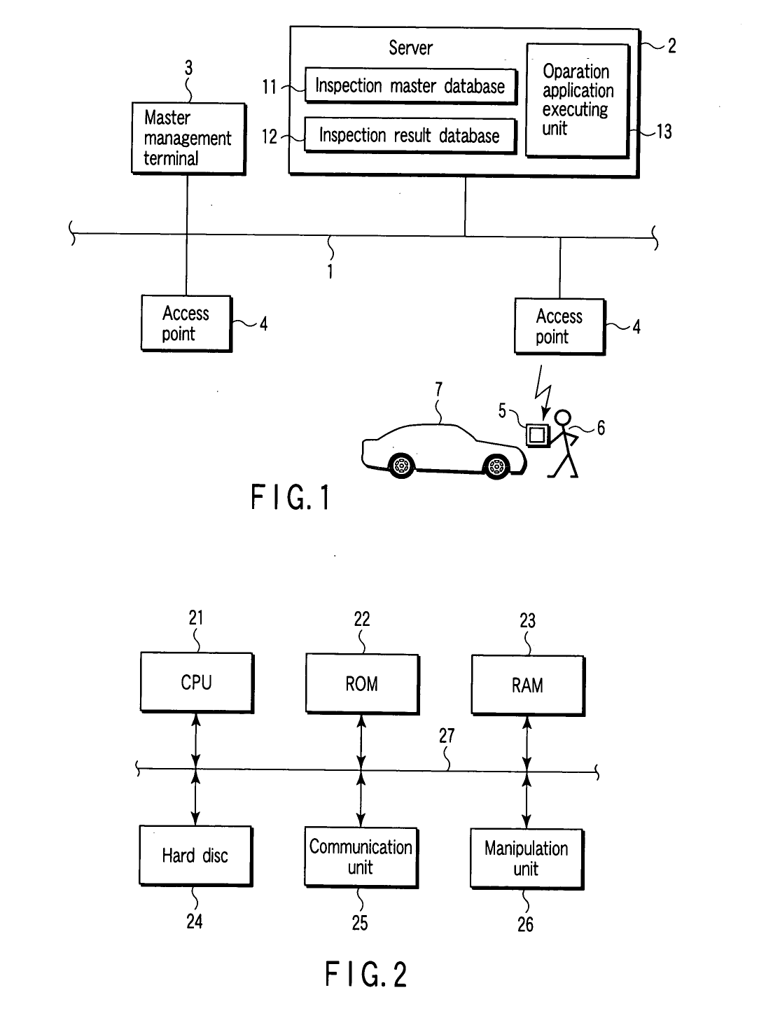

FIG. 1 is a diagram showing the arrangement of a vehicle inspection management system, in which a server 2 and a master management terminal 3 are connected to a LAN 1 disposed in a vehicle manufacturing factory as well as a plurality of access points 4 are connected to the LAN 1 at predetermined intervals. Radio communications are executed with mobile inspection terminals 5 acting as inspection terminals located in the vicinity of the access points 4 through the access points 4.

The mobile inspection terminals 5 are carried by inspection workers 6, and each time a predetermined process is finished in a manufacturing line, an inspection worker 6 inspects a plurality of sections and parts to be inspected, which are assembled to a vehicle 7, by manipulating a mobile inspection terminal 5.

The server 2 is provided with an inspection master database 11 and an inspection result database 12. Further, the server 2 is provided with an operation application executing unit 13 for executing a function for registering threshold values for standard inspection times and warning, and a function for managing, comparing, and inquiring about actual inspection times, the number of warnings, and the like.

The inspection master database 11 includes the inspection standard specification information, the measured values of inspection standards, and the like of sections and parts to be inspected together with the identification codes, the models, and the like of vehicles to be manufactured. Further, standard inspection times for respective inspection items and the threshold values for warning are registered to the inspection master database 11 using the operation application executing unit 13. The inspection result database 12 stores the actual inspection times and the number of times of warning on one inspection screen input from the respective mobile inspection terminals 5.

As shown in FIG. 2, the server 2 is provided with a CPU (central processing unit) 21, a ROM (read only memory) 22, a RAM (random access memory) 23, a hard disc device 24, a communication unit 25, and a manipulation unit 26, and they are electrically connected to each other through a bus line 27. The CPU 21 constitutes a controller main body, the ROM 22 stores program data through which the CPU 21 controls respective components, the RAM 23 includes a memory temporarily used by the CPU 21 when it transmits and receives data, processes data, and the like, the hard disc device 24 stores the inspection master database 11, the inspection result database 12, and the like, the communication unit 25 transmits and receives data to and from the master management terminal 3 through the LAN 1 as well as transmits and receives data to and from the mobile inspection terminals 5 through the LAN 1 and the access points 4, and the manipulation unit 26 is used to input data through keys, display indicators, and the like.

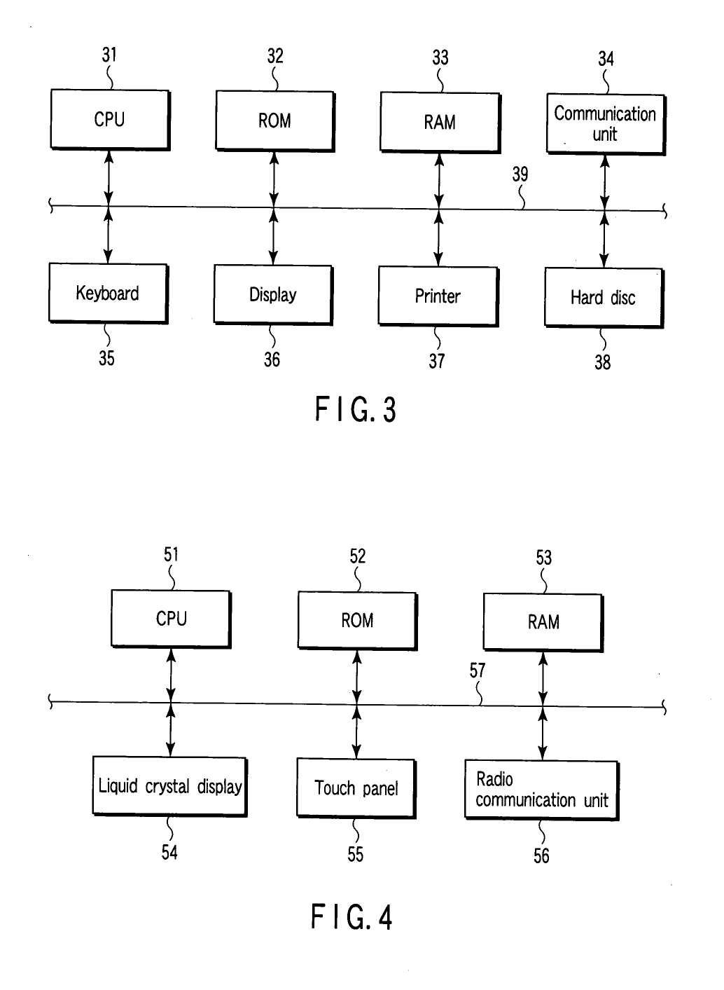

The master management terminal 3 is a terminal manipulated by a manager of the manufacturing line. As shown in FIG. 3, the master management terminal 3 is provided with a CPU 31, a ROM 32, a RAM 33, a communication unit 34, a keyboard 35, a display 36, a printer 37, and a hard disc device 38, and they are electrically connected to each other through a bus line 39. The CPU 31 constitutes a controller main body, the ROM 32 stores program data through which the CPU 31 controls respective components, the RAM 33 includes a memory temporarily used by the CPU 31 when it transmits and receives data, processes data, and the like, a memory for storing a small amount of data, and the like, the communication unit 34 transmits and receives data to and from the server 2 through the LAN 1, the keyboard 35 includes various keys for executing jobs, the display 36 is composed of a liquid crystal display and the like and displays data and the like, the printer 37 prints and outputs necessary data, and the hard disc device 38 is used to store a large amount of data.

As shown in FIG. 4, the mobile inspection terminals 5 is provided with a CPU 51, a ROM 52, a RAM 53, a liquid crystal display 54, a touch panel 55, and a radio communication unit 56, and they are electrically connected to each other through a bus line 57. The CPU 51 constitutes a controller main body, the ROM 52 stores program data through which the CPU 51 controls respective components, the RAM 53 includes a memory temporarily used by the CPU 51 when it transmits and receives data, processes data, and the like, a memory for storing a small amount of data, and the like, the liquid crystal display 54 displays data, input screens on which various information is input, and the like, the touch panel 55 is placed on the liquid crystal display 54 through which information is input on an input screen displayed on the liquid crystal display 54, and the radio communication unit 56 transmits and receives data to and from the access points 4 by radio communication.

Inspection information, which indicates what types of inspection are executed on which sections and parts of vehicles to be manufactured in respective processes, is input through the master management terminal 3 and registered to the inspection master database 11. Parts are inspected in the respective processes after they are welded, painted, and assembled. There are input standard inspection times and threshold values of warning for respective inspection items used in inspection.

When a standard inspection time of each inspection item is registered, the master management terminal 3 displays a master data input screen on the display 36. For example, when a standard inspection time for a “tire brand” is input and registered as a standard inspection man hour on the input screen, it is registered in the inspection master database 11.

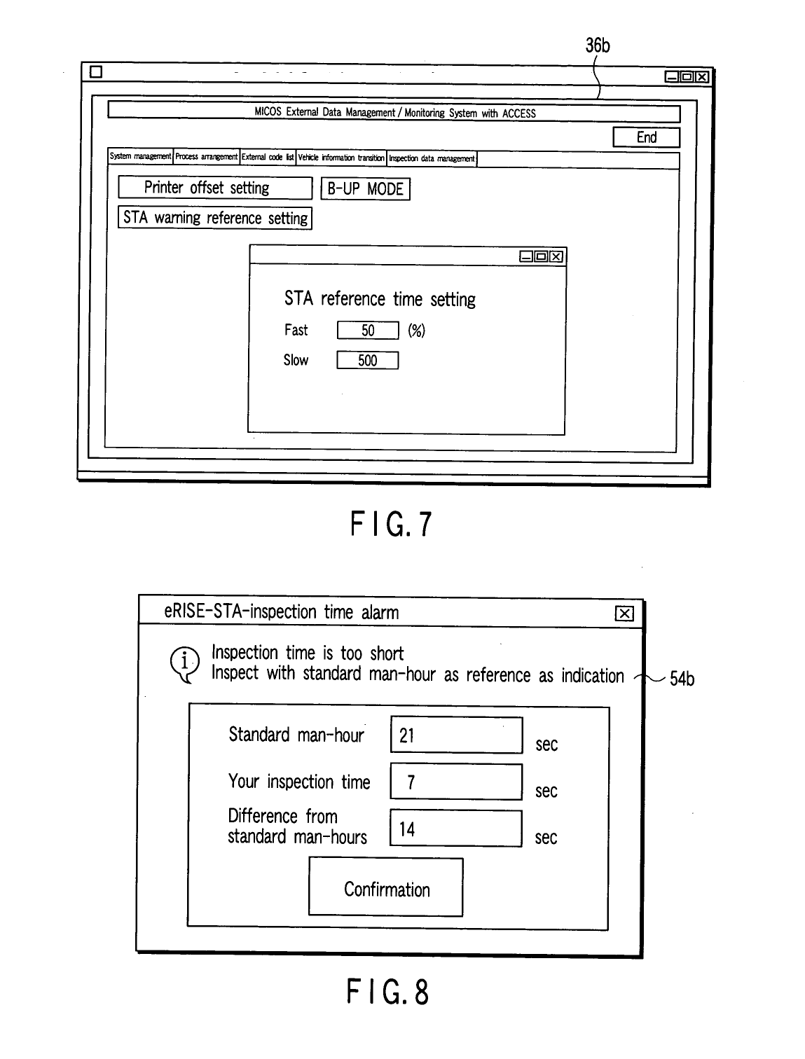

Further, when the threshold values for warning are registered, a master data input screen 36b is displayed on the display 36 to determine the upper limit value and the lower limit value of the standard inspection time as shown in FIG. 7. The lower limit value is set to a time shorter than the standard inspection time, and the upper limit value is set to a time longer than it. The master data input screen 36b shows that the lower limit value is set to 50% of the standard inspection time and the upper limit value is set to 500% of it.

A welding job, a painting job, an assembly job, and the like are sequentially executed in the respective processes of the manufacturing line, and the contents of the jobs executed in the respective processes are also inspected in the processes. The inspection is executed by an inspection worker by receiving the information of an inspection item in a process of a vehicle from the inspection master database 11 through radio communication from the mobile inspection terminal 5 to the server 2 and displaying the information on the mobile inspection terminal 5.

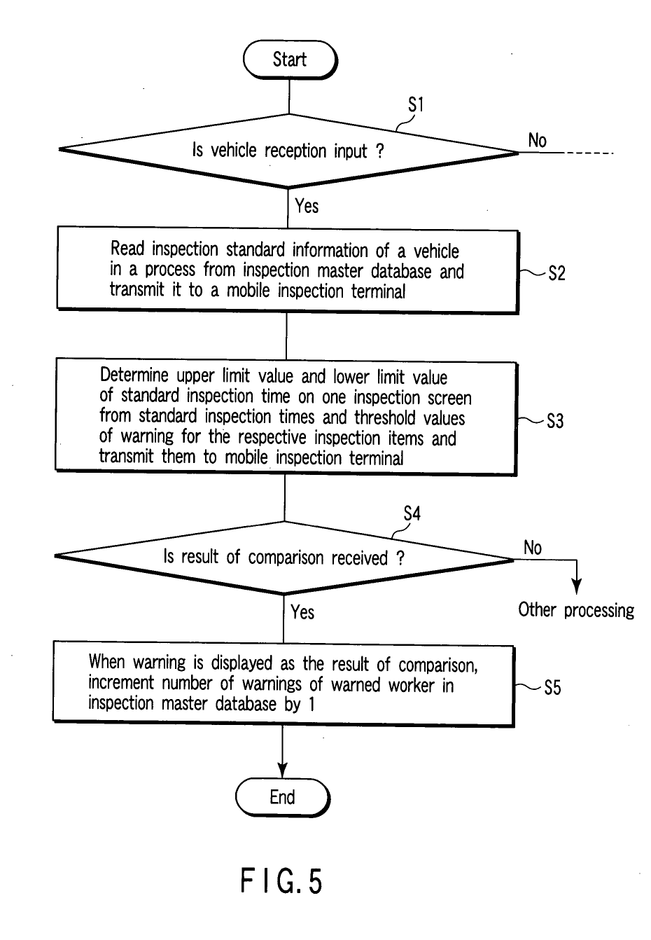

In the inspection job executed in the process, when the server 2 confirms the input of vehicle reception from the mobile inspection terminal 5 in step S1 as shown in FIG. 5, the server 2 reads out the inspection standard of the vehicle in the process from the inspection master database 11 and transmits it to the mobile inspection terminal 5 in step S2 (first transmission means).

Subsequently, in step S3, the server 2 determines the upper limit value and the lower limit value of the standard inspection time on one inspection screen from the standard inspection times and the threshold values of warning for the respective inspection items registered to the inspection master database 11 and transmits them to the mobile inspection terminal 5 (second transmission means).

Thereafter, the inspection worker executes inspection and receives a result of comparison of whether or not an actual inspection time is beyond the range between the upper limit value and the lower limit value of the standard inspection time from the mobile inspection terminal 5 in step S4. When a warning is displayed as the result of comparison, the number of warnings to the inspection worker is incremented by 1 in the inspection master database 11.

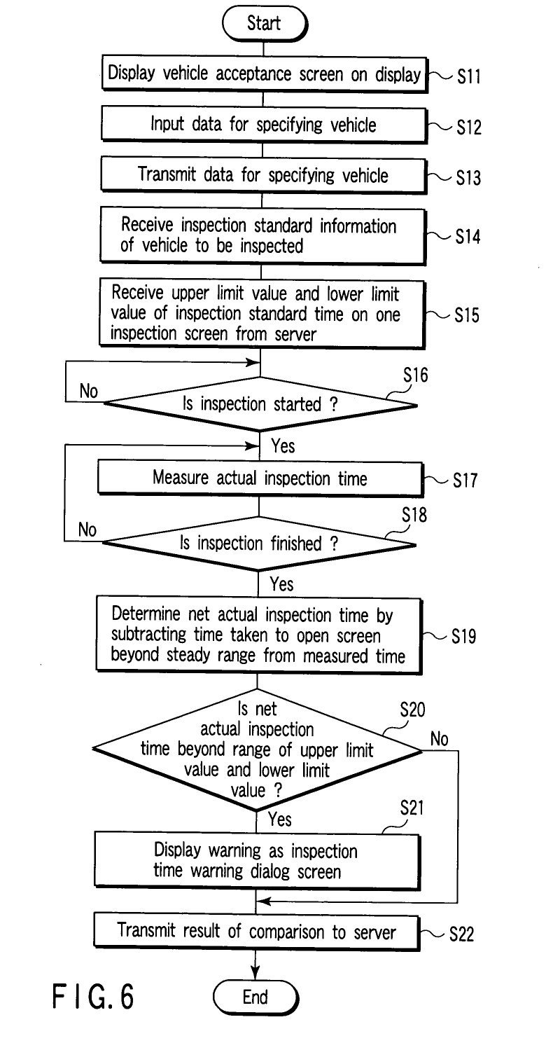

The mobile inspection terminal 5 executes processing based on a flowchart of FIG. 6. That is, in step S11, the mobile inspection terminal 5 displays a vehicle reception screen on the liquid crystal display 54. Subsequently, in step S12, data for specifying a vehicle to be inspected is input on the vehicle reception screen. In step S13, the mobile inspection terminal 5 transmits the data for specifying the vehicle to be inspected to the server 2.

In this state, the mobile inspection terminal 5 receives the inspection standard of the vehicle to be inspected from the server 2 and displays an inspection screen on the liquid crystal display 54 in step S14 (first display means). Further, in step S15, the mobile inspection terminal 5 receives the upper limit value and the lower limit value of the standard inspection time on the one inspection screen from the server 2.

When the mobile inspection terminal 5 confirms that the inspection is started in step S16, it measures an actual inspection time in step S17 (time measurement means). Note that the actual inspection time is measured by providing a timer with the RAM 53 and incrementing the actual inspection time by 1 each time the timer counts, for example, 1 second.

When the mobile inspection terminal 5 determines in step S18 that the inspection related to the inspection item shown on the one inspection screen is finished, it determines an actual net inspection time in step S19 by subtracting a time taken for a job which is not included in a steady job range, for example, a time taken to manipulate a screen, which is displayed during the inspection regardless of whether or not it directly relates to the inspection, from the time measured by the timer.

Subsequently, the mobile inspection terminal 5 determines in step S20 whether or not the actual inspection time is beyond the range between the upper limit value and the lower limit value of the standard inspection time. When the actual inspection time is beyond the range, the mobile inspection terminal 5 displays a warning on the liquid crystal display 54 as an inspection time warning dialog screen 54b in step S21 (second display means). Then, the mobile inspection terminal 5 transmits a result of comparison to the server 2 in step S22.

In the arrangement described above, the mobile inspection terminal 5 receives the inspection screen of a vehicle in a process from the server 2 and displays it on the liquid crystal display 54, and an inspection job is executed for the inspection items displayed on the inspection screen. At the time, standard inspection times, which are necessary to inspect the respective displayed inspection items, are displayed on the inspection screen. Thus, an inspection worker can easily know how much time may be taken for inspection jobs to be executed from now, and further, can approximately match inspection times with the standard inspection times easily, thereby it can be prevented that the inspection job is insufficiently executed.

When an inspection job is started, the mobile inspection terminal 5 measures an actual inspection time with the timer. On the completion of the inspection for the respective displayed inspection items, the mobile inspection terminal 5 determines an actual net inspection time by subtracting the time taken for a job beyond the steady job range from the actual inspection time measured by the timer. Then, the mobile inspection terminal 5 makes comparison of whether or not the actual net inspection time is within the range between the upper limit value and the lower limit value of the standard inspection time received from the server 2 using the upper limit value and the lower limit value.

When for example, the upper limit value is 500% of the standard inspection time of “21” seconds, the upper limit of the standard inspection time is “105 seconds”, and when the lower limit value is 50% thereof, the lower limit of the standard inspection time is about “10 seconds”. In this case, the mobile inspection terminal 5 determines whether or not the actual inspection time is within the range from 10 seconds to 105 seconds. When, for example, the actual inspection time is seven seconds, it is beyond the lower limit value, from which the mobile inspection terminal 5 determines that the inspection job is executed too fast. In this case, the inspection time warning dialog screen 54b as shown in FIG. 8 is displayed on the liquid crystal display 54 to warn that the inspection job was executed too fast.

Accordingly, the inspection worker can know that he or she executed the inspection job too quickly. Since the screen 54b displays the standard inspection time (standard man hours), the inspection time taken in the inspection job executed currently, and the difference between the inspection time and the standard inspection time, the inspection worker can also know how fast the inspection job was executed. Accordingly, the inspection time can be approximately matched with the standard inspection time easily. The awareness of the inspection workers for keeping to the inspection time can be improved by the above arrangement, thereby it can be prevented that an inspection job is executed insufficiently.

Since the number of warnings issued to each inspection worker is managed by the inspection result database 12 of the server 2, it is possible to pick out inspection workers warned many times in a predetermined period and to give them special advice.

It should be noted that the mobile inspection terminals are used as inspection terminals and the communication is executed by the radio communication system through the server 2 and the access points 4 in the embodiment. However, the present invention is by no means limited thereto and stationary inspection terminals which are wired through the server 2, the LAN, and the like may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A vehicle inspection management system comprising:
a server for use in a vehicle manufacturing line; and,
inspection terminals which communicate with the server through a LAN,
wherein the server comprises:
an inspection master database configured to store inspection standard information of the vehicle and to register the standard inspection times for respective inspection items and threshold values for issuing a warning to a worker in charge of inspection when the standard inspection times deviate;
an inspection result database configured to store actual inspection times on one inspection screen transmitted from the inspection terminals;
first transmission section configured to, when vehicle reception is input from the inspection terminal, read out the inspection standard information of the vehicle in a process and transmit the inspection standard information to the inspection terminal; and
second transmission section configured to determine the upper limit values and the lower limit values of the standard inspection times on the one inspection screen from the standard inspection times of the respective inspection items and the threshold value for warning and transmit the upper limit values and the lower limit values to the inspection terminal, and
each of the inspection terminals comprises:
a display;
first display section configured to receive the inspection standard information of the vehicle to be inspected from the server and display an inspection screen on the display;
time measurement section configured to measure actual inspection times when inspection jobs are executed for the inspection items on the one inspection screen being displayed;
comparison section configured to, on the completion of the inspection jobs of the respective inspection items displayed on the one inspection screen, compare the actual inspection times measured by the time measurement means with the upper limit values or the lower limit values of the standard inspection times; and,
second display section configured to, when the results of comparison deviates from the threshold values, display warnings including the results of comparison on the display as an inspection time warning dialog screen.

2. A vehicle inspection management system according to claim 1, wherein,
the server further determines the standard inspection times of the respective inspection screens and transmits the standard inspection times to the inspection terminal together with inspection standard information, and,
the inspection terminal displays an inspection screen on the display as well as displays the standard inspection times on the inspection screen.

3. A vehicle inspection management system according to claim 1, wherein,
the server further stores the numbers of warnings issued when the actual inspection time of each inspection worker is longer than the standard inspection time and when the actual inspection time is shorter than the standard inspection time, respectively, and,
the number of warnings issued to a worker in charge of inspection in the inspection result database is incremented when the comparison section of the inspection terminal determines that the actual inspection time deviates from the range of the upper limit value and the lower limit value of the standard inspection time.

4. A vehicle inspection management system according to claim 2, wherein,
the server further stores the numbers of warnings issued when the actual inspection time of each inspection worker is longer than the standard inspection time and when the actual inspection time is shorter than the standard inspection time, respectively, and,
the number of warnings issued to an inspection worker in the inspection result database is incremented when the comparison section of the inspection terminal determines that the actual inspection time deviates from the range of the upper limit value and the lower limit value of the standard inspection time.

5. A vehicle inspection management method comprising:
a server for use in a vehicle manufacturing line; and,
inspection terminals which communicate with the server through a LAN,
wherein the server comprises the steps of:
first transmission step, when vehicle reception is input from the inspection terminal, reading out the inspection standard information of the vehicle in a process and transmit the inspection standard information to the inspection terminal; and
second transmission step determining the upper limit values and the lower limit values of the standard inspection times on the one inspection screen from the standard inspection times of the respective inspection items and the threshold value for warning and transmit the upper limit values and the lower limit values to the inspection terminal, and
each of the inspection terminals comprises the steps of:
first display step receiving the inspection standard information of the vehicle to be inspected from the server and display an inspection screen on a display;
time measurement step measuring actual inspection times when inspection jobs are executed for the inspection items on the one inspection screen being displayed;
comparison step, on the completion of the inspection jobs of the respective inspection items displayed on the one inspection screen, comparing the actual inspection times measured by the time measurement section with the upper limit values or the lower limit values of the standard inspection times; and,
second display step, when the results of comparison deviates from the threshold values, displaying warnings including the results of comparison on the display as an inspection time warning dialog screen.

6. A vehicle inspection management method according to claim 5, wherein,
the server further determines the standard inspection times of the respective inspection screens and transmits the standard inspection times to the inspection terminal together with inspection standard information, and,
the inspection terminal displays an inspection screen on the display as well as displays the standard inspection times on the inspection screen.

7. A vehicle inspection management method according to claim 5, wherein,
the server further stores the numbers of warnings issued when the actual inspection time of each inspection worker is longer than the standard inspection time and when the actual inspection time is shorter than the standard inspection time, respectively, and,
the number of warnings issued to a worker in charge of inspection in the inspection result database is incremented when the comparison section of the inspection terminal determines that the actual inspection time deviates from the range of the upper limit value and the lower limit value of the standard inspection time.

8. A vehicle inspection management method according to claim 6, wherein,
the server further stores the numbers of warnings issued when the actual inspection time of each inspection worker is longer than the standard inspection time and when the actual inspection time is shorter than the standard inspection time, respectively, and,
the number of warnings issued to an inspection worker in the inspection result database is incremented when the comparison section of the inspection terminal determines that the actual inspection time deviates from the range of the upper limit value and the lower limit value of the standard inspection time.
